(19) United States
(12) Patent Application Publication
(10) Pub. No.: US 2008/0046835 A1
(43) Pub. Date: Feb. 21, 2008

(54) OBJECT-ORIENTED PROCESSING OF TAB TEXT

(76) Inventors: Truc NGUYEN, San Diego, CA (US); Katie KUWATA, Oceanside, CA (US); William SU, Riverside, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/769,416

(22) Filed: Jun. 27, 2007

Related U.S. Application Data
(63) Continuation-in-part of application No. 11/252,485, filed on Oct. 18, 2005, now abandoned.
Application No. 11/252,485 is a continuation-in-part of application No. 10/205,307, filed on Jul. 24, 2002.
Application No. 11/252,485 is a continuation-in-part of application No. 10/201,886, filed on Jul. 24, 2002.
Application No. 11/252,485 is a continuation-in-part of application No. 10/157,525, filed on May 28, 2002, now abandoned.

(51) Int. Cl. G06F 3/048

(52) U.S. Cl. 715/777

(57) ABSTRACT

The subject application is directed to a system and method for tab text management. A user is prompted, via a thin client interface, for tab formatting data which includes tab stock identification data, position data of the tab sheet relative to the electronic document, and caption data. The received tab formatting data is stored in an associated object file. A document file is then received representing an electronic document associated with the tab formatting data. The electronic document data and the object file are then merged so as to generate output data. The generated output data includes the electronic document data with relative defined tabbed page portions according to the tab formatting data disposed within the object file. A printout of a tangible document according to the electronic data file is commenced, with the tangible document including tab pages interspersed within the tangible document based upon tab formatting data.

### CROSS-REFERENCE TO RELATED APPLICATIONS

This application is a Continuation-In-Part of U.S. application Ser. No. 11/252,485, filed on Oct. 18, 2005, which is a Continuation-In-Part of U.S. application Ser. No. 10/205,307, filed on Jul. 24, 2002, U.S. application Ser. No. 10/201,886, filed on Jul. 24, 2002, and U.S. application Ser. No. 10/157,525, filed on May 28, 2002, the contents of all which are incorporated herein by reference

### BACKGROUND OF THE INVENTION

The subject application is directed to a system and method for tab text management. More particularly, the subject application is directed to an object-oriented system and method for user-friendly management of tab text. In particular, the subject application is directed to a system and method to structure tab text as self-organized objects capable of being edited, inserted, and deleted in a manner similar to document text content.

A tab, as is commonly known, is the protruding portion of, for example, a sheet of paper that typically extends beyond the general outline of the paper medium to facilitate an indexing function. A tab sheet manufactured to include the tab is used as a document separator in a document compilation to mark the beginning of a section or chapter that comprises the compilation of multiple pages of similar print medium. The tab is usually printed with an alphanumeric text caption to facilitate searching by a user for the section of interest in the compilation.

Once conventional method for generating tab information requires the user to utilize an advanced word processing program to create a text box, and to position the text box where the user wants the tab text to appear on the tab document to be printed. Thus, the user first needs to estimate the position of the tab index on the page, position the text box, select the font and size, modify the orientation for the text, enter the text, and finally, adjust the position of the text. Consequently, such conventional tab management architecture involves many steps that are time-consuming, and furthermore, the tab information cannot be modified or re-positioned easily, if desired, at a later time.

### SUMMARY OF THE INVENTION

In accordance with one embodiment of the subject application, there is provided a system and method for tab text management.

Further, in accordance with one embodiment of the subject application, there is provided an object-oriented system and method for user-friendly management of tab text.

Still further, in accordance with one embodiment of the subject application, there is provided a system and method to structure tab text as self-organized objects capable of being edited, inserted, and deleted in a manner similar to document text content.

Further, in accordance with one embodiment of the subject application, there is provided a system for tab text management. The system includes interface means adapted for prompting an associated user, via a thin client interface, for tab formatting data corresponding to at least one associated electronic document for which a printout is desired. The tab formatting data includes tab stock identification data representing a selected tab sheet stock associated with tab pages, position data representing the positioning of tab sheet stock relative to portions of the electronic document, and caption data representing indicia for printing on the selected tab sheet stock. The system further includes means adapted for storing received tab formatting data in an associated object file and means adapted for receiving a document data file representative of an electronic document associated with the tab formatting data. The system also comprises means adapted for merging the electronic document data and the object file so as to generate output data including the electronic document data having tabbed page portions defined relative thereto in accordance with the tab formatting data disposed in the object file. In addition, the system includes means adapted for commencing a printout of a tangible document in accordance with the electronic data file, and which tangible document includes tab pages printed and interspersed therein in accordance with the tab formatting data.

In one embodiment of the subject application, the system further includes means adapted for storing pre-defined tab stock property data associated with a plurality of tab stock types. In such an embodiment, the system also comprises means adapted for positioning caption data on the selected tab sheet stock in accordance with stock property data corresponding to received stock identification data.

In another embodiment of the subject application, the interface means further includes means adapted for prompting the associated user for tab formatting data including text string data inclusive of selected text, which string data forms at least a portion of the caption data.

In yet another embodiment of the subject application, the system also comprises sequencing means adapted for generating a numeric sequence portion of the string data such that tab pages include numerically sequenced data therebetween. In such an embodiment of the subject application, the system includes means adapted for storing pre-defined tab stock property data associated with a plurality of tab stock types and means adapted for positioning caption data on the selected tab sheet stock in accordance with stock property data corresponding to received stock identification data.

Still further, in accordance with one embodiment of the subject application, there is provided a method for tab text management in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for tab text management according to one embodiment of the subject application;

FIG. 2A is a view representing an output media storage tray for use in the system for tab text management according to one embodiment of the subject application;

FIG. 2B is a view representing a single output media for use in the system for tab text management according to one embodiment of the subject application;

FIG. 3 is a block diagram illustrating device hardware for use in the system for tab text management according to one embodiment of the subject application;

FIG. 4 is a functional diagram illustrating the device for use in the system for tab text management according to one embodiment of the subject application;

FIG. 5 is a block diagram illustrating controller hardware for use in the system for tab text management according to one embodiment of the subject application;

FIG. 6 is a functional diagram illustrating the controller for use in the system for tab text management according to one embodiment of the subject application;

FIG. 7 is a functional block diagram illustrating an example of the system for tab text management according to one embodiment of the subject application;

FIG. 8 is a screen template illustrating a graphical user interface for use in the system for tab text management according to one embodiment of the subject application;

FIG. 9 is a screen template illustrating a graphical user interface for use in the system for tab text management according to one embodiment of the subject application;

FIG. 10 is a screen template illustrating a graphical user interface for use in the system for tab text management according to one embodiment of the subject application;

FIG. 11 is a flowchart illustrating a method for tab text management according to one embodiment of the subject application; and

FIG. 12 is a flowchart illustrating a method for tab text management according to one embodiment of the subject application.

### DETAILED DESCRIPTION OF THE PREFERRED EMBODIMENT

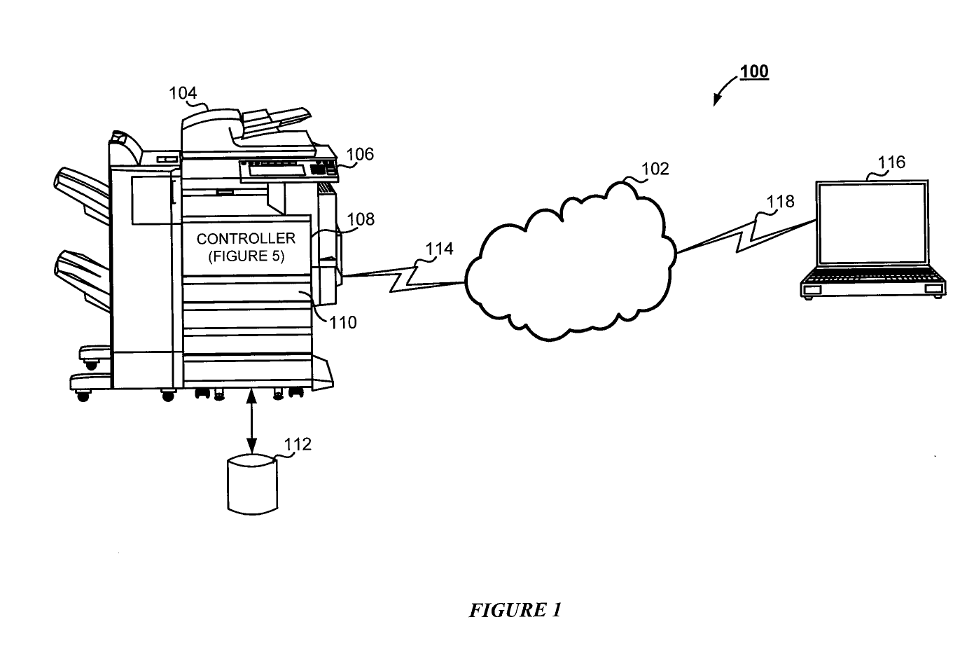

The subject application is directed to a system and method for tab text management. In particular, the subject application is directed to an object-oriented system and method for user-friendly management of tab text. More particularly, the subject application is directed to a system and method that allows a user to structure tab text as self-organized objects capable of being edited, inserted, and deleted in a manner similar to document text content. It will become apparent to those skilled in the art that the system and method described herein are suitably adapted to a plurality of varying electronic fields employing object-oriented modifications, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for tab text management in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

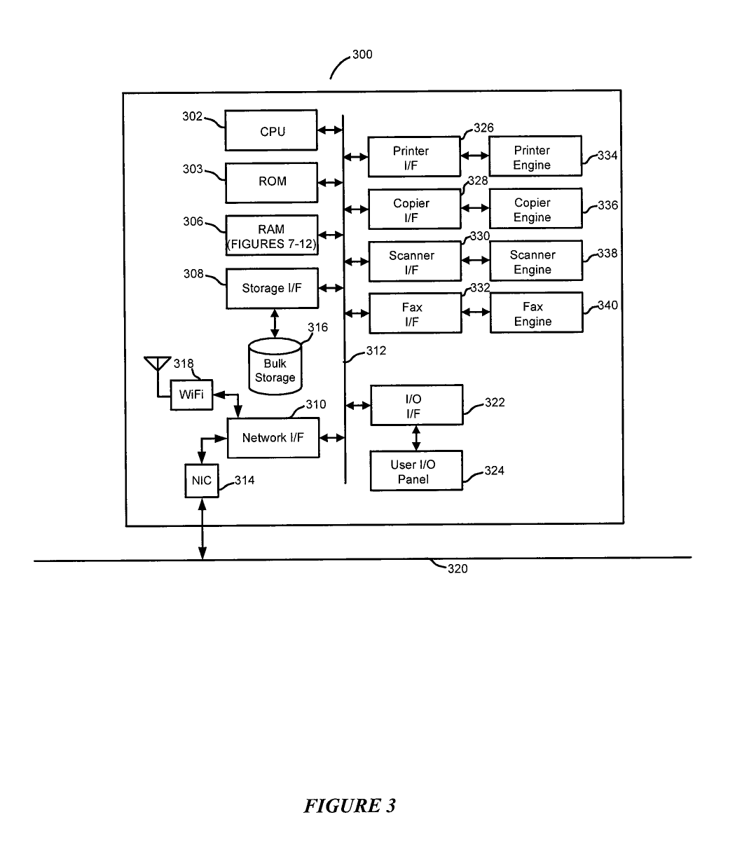

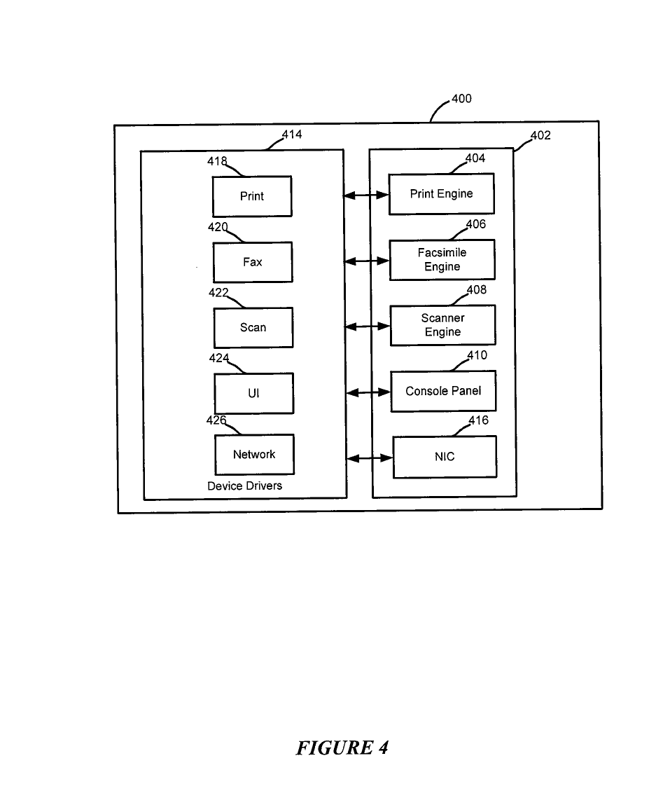

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 114. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will better be understood in conjunction lo with the block diagrams illustrated in FIGS. 3 and 4, explained in greater detail below.

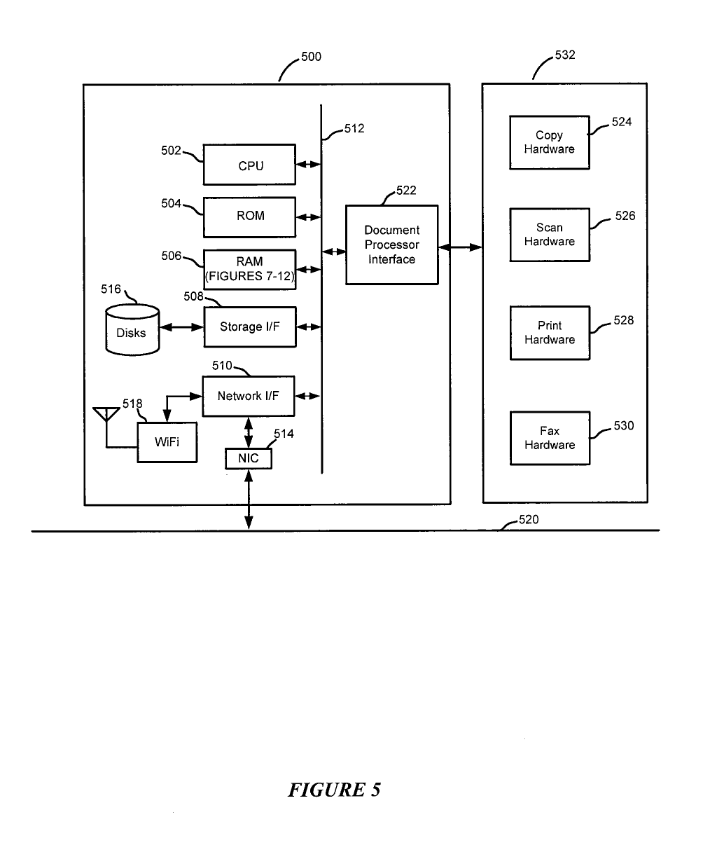

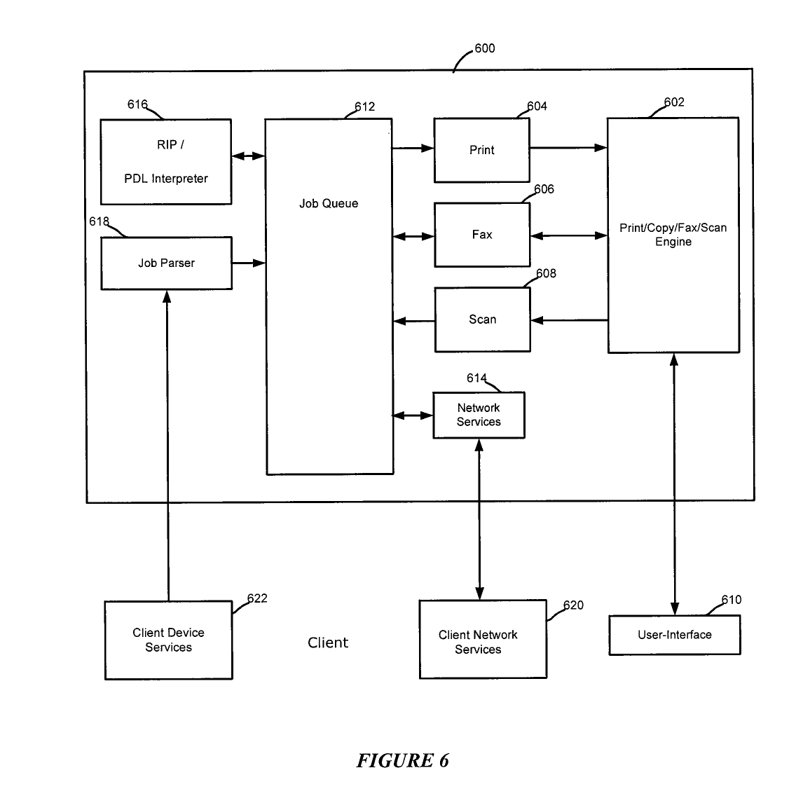

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for tab text management of the subject application. The functioning of the controller 108 will better be understood in conjunction with the block diagrams illustrated in FIGS. 5 and 6, explained in greater detail below.

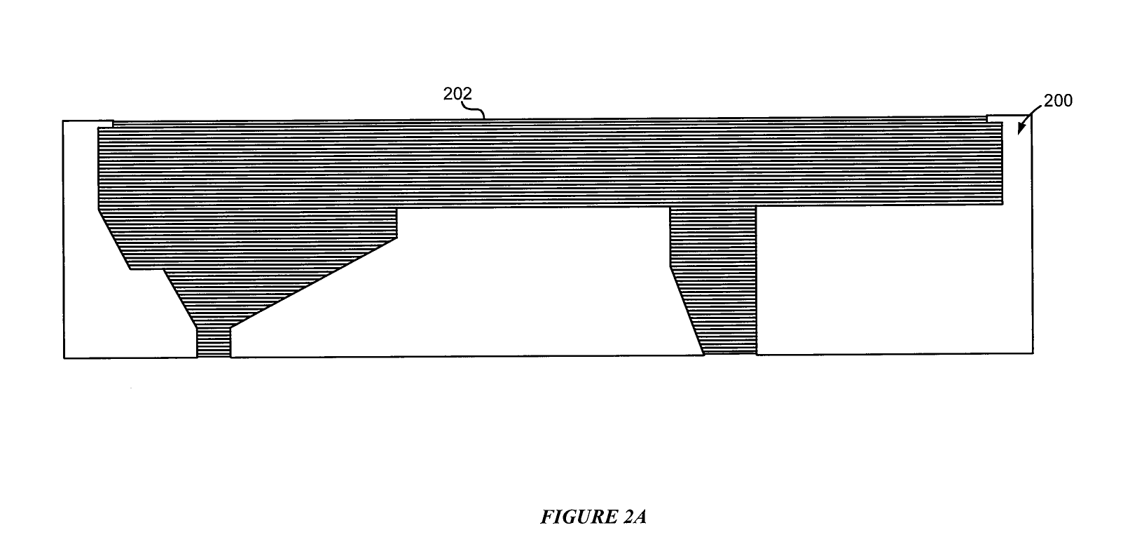

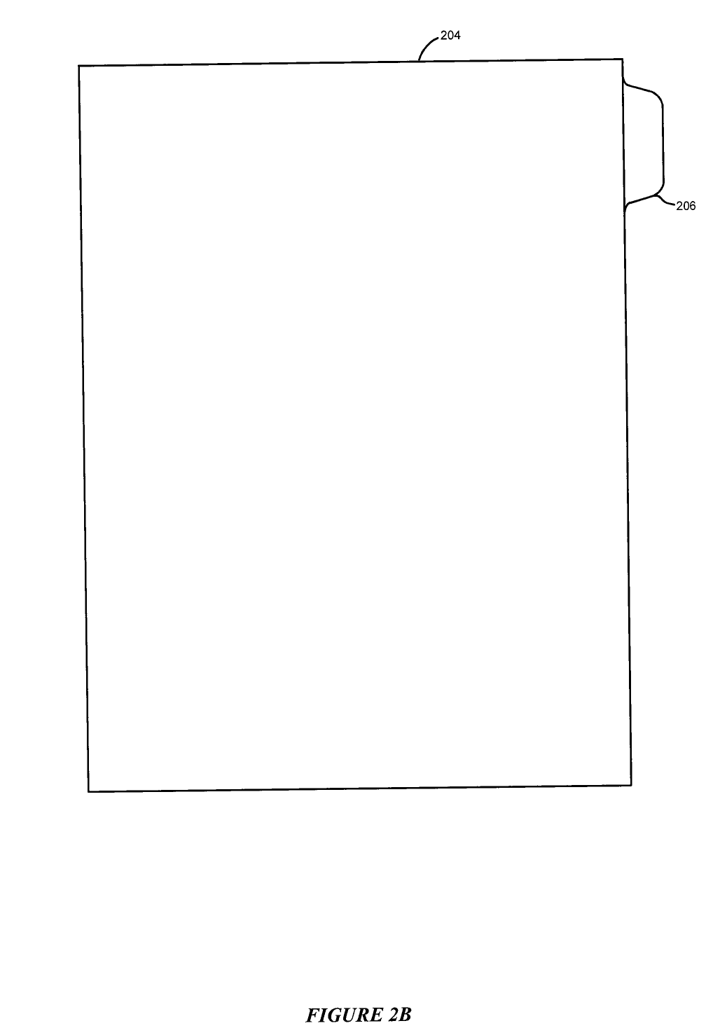

As depicted in FIG. 1, the document processing device 104 further includes one or more media storage trays 110, suitably configured to stored output media for output by the document processing device 110. The skilled artisan will appreciate that the media storage tray 110 is representative of any of a myriad of storage components associated with the document processing device 104 capable of storing sheets of paper of varying sizes, sheets of transparencies, blank greeting cards, blank business cards, photographic paper, or any other output medium upon which documents or images are rendered. A close-up view of the media storage tray 110 is shown in FIG. 2A, discussed in greater detail below.

Communicatively coupled to the document processing device 104 is a data storage device 112. In accordance with the preferred embodiment of the subject application, the data storage device 112 is any mass storage device known in the art including, for example and without limitation, magnetic storage drives, a hard disk drive, optical storage devices, flash memory devices, or any suitable combination thereof. In the preferred embodiment, the data storage device 112 is suitably adapted to store a document data, image data, electronic database data, or the like. It will be appreciated by those skilled in the art that while illustrated in FIG. 1 as being a separate component of the system 100, the data storage device 112 is capable of being implemented as internal storage component of the document processing device 104, a component of the controller 108, or the like, such as, for example and without limitation, an internal hard disk drive, or the like.

The system 100 illustrated in FIG. 1 further depicts a user device 116, in data communication with the computer network 102 via a communications link 118. It will be appreciated by those skilled in the art that the user device 116 is shown in FIG. 1 as a laptop computer for illustration purposes only. As will be understood by those skilled in the art, the user device 116 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 118 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 116 is suitably adapted to generate and transmit electronic documents, document processing instructions, user interface modifications, upgrades, updates, personalization data, or the like, to the document processing device 104, or any other similar device coupled to the computer network 102.

Referring now to FIG. 2A, there is shown a representation diagram illustrating a media storage tray 200 associated with the document processing device 104. As depicted in FIG. 2A, the storage tray 200 includes a plurality of output media 202, illustrated as paper output media in accordance with one embodiment of the subject application. It will be appreciated by those skilled in the art that the output media storage tray 200 of the subject application is capable of being configured to store any of a myriad of output media known in the art including, for example and without limitation, paper, greeting card blanks, poster board, transparencies, business card blanks, envelopes, or the like. The skilled artisan will further appreciate that the output media 202 shown in FIG. 2A is capable of implementation in a plurality of various sizes, e.g., letter, ledger, A4, legal, A5, or the like, dependent upon the type and size of media available to associated document processing device 104. FIG. 2B illustrates a single tab sheet stock 204 corresponding to the output media 202 of FIG. 2A. As shown in FIG. 2B, the single tab sheet stock 204 includes a tab 206 upon which caption indicia is printed during output of a tangible document according to the subject application. It will be appreciated by those skilled in the art that the placement of the tab 206 of the stock 204 is for example purposes only, and other placements on a sheet stock 204 so as to prevent overlap, as will be understood by those skilled in the art, are capable of implementation in accordance with the subject application.

Turning now to FIG. 3, illustrated is a representative architecture of a suitable device 300 on which operations of the subject system are completed. Included is a processor 302, suitably comprised of a central processor unit. However, it will be appreciated that the processor 302 may advantageously be composed of multiple processors working in concert with one another as will be appreciated by one of ordinary skill in the art. Also included is a non-volatile or read only memory 304 which is advantageously used for static or fixed data or instructions, such as BIOS functions, system functions, system configuration data, and other routines or data used for operation of the device 300.

Also included in the device 300 is random access memory 306, suitably formed of dynamic random access memory, static random access memory, or any other suitable, addressable memory system. Random access memory provides a storage area for data instructions associated with applications and data handling accomplished by the processor 302.

A storage interface 308 suitably provides a mechanism for volatile, bulk or long term storage of data associated with the device 300. The storage interface 308 suitably uses bulk storage, such as any suitable addressable or serial storage, such as a disk, optical, tape drive and the like as shown as 316, as well as any suitable storage medium as will be appreciated by one of ordinary skill in the art.

A network interface subsystem 310 suitably routes input and output from an associated network allowing the device 300 to communicate to other devices. The network interface subsystem 310 suitably interfaces with one or more connections with external devices to the device 300. By way of example, illustrated is at least one network interface card 314 for data communication with fixed or wired networks, such as Ethernet, token ring, and the like, and a wireless interface 318, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 314 is interconnected for data interchange via a physical network 320, suitably comprised of a local area network, wide area network, or a combination thereof.

Data communication between the processor 302, read only memory 304, random access memory 306, storage interface 308 and the network subsystem 310 is suitably accomplished via a bus data transfer mechanism, such as illustrated by bus 312.

Suitable executable instructions on the device 300 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 322 to a user input/output panel 324 as will be appreciated by one of ordinary skill in the art.

Also in data communication with bus 312 are interfaces to one or more document processing engines. In the illustrated embodiment, printer interface 326, copier interface 328, scanner interface 330, and facsimile interface 332 facilitate communication with printer engine 334, copier engine 336, scanner engine 338, and facsimile engine 340, respectively. It is to be appreciated that the device 300 suitably accomplishes one or more document processing functions. Systems accomplishing more than one document processing operation are commonly referred to as multifunction peripherals or multifunction devices.

Turning now to FIG. 4, illustrated is a suitable document processing device for use in connection with the disclosed system. FIG. 4 illustrates suitable functionality of the hardware of FIG. 3 in connection with software and operating system functionality as will be appreciated by one of ordinary skill in the art. The document processing device 400 suitably includes an engine 402 which facilitates one or more document processing operations.

The document processing engine 402 suitably includes a print engine 404, facsimile engine 406, scanner engine 408 and console panel 410. The print engine 404 allows for output of physical documents representative of an electronic document communicated to the processing device 400. The facsimile engine 406 suitably communicates to or from external facsimile devices via a device, such as a fax modem.

The scanner engine 408 suitably functions to receive hard copy documents and in turn image data corresponding thereto. A suitable user interface, such as the console panel 410, suitably allows for input of instructions and display of information to an associated user. It will be appreciated that the scanner engine 408 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 4, the document processing engine also comprises an interface 416 with a network via driver 426, suitably comprised of a network interface card. It will be appreciated that a network thoroughly accomplishes that interchange via any suitable physical and non-physical layer, such as wired, wireless, or optical data communication.

The document processing engine 402 is suitably in data communication with one or more device drivers 414, which device drivers allow for data interchange from the document processing engine 402 to one or more physical devices to accomplish the actual document processing operations. Such document processing operations include one or more of printing via driver 418, facsimile communication via driver 420, scanning via driver 422 and a user interface functions via driver 424. It will be appreciated that these various devices are integrated with one or more corresponding engines associated with the document processing engine 402. It is to be appreciated that any set or subset of document processing operations are contemplated herein. Document processors which include a plurality of available document processing options are referred to as multi-function peripherals.

Turning now to FIG. 5, illustrated is a representative architecture of a suitable backend component, i.e., the controller 500, shown in FIG. 1 as the controller 108, on which operations of the subject system 100 are completed. The skilled artisan will understand that the controller 500 is representative of any general computing device, known in the art, capable of facilitating the methodologies described herein. Included is a processor 502, suitably comprised of a central processor unit. However, it will be appreciated that processor 502 may advantageously be composed of multiple processors working in concert with one another as will be appreciated by one of ordinary skill in the art. Also included is a non-volatile or read only memory 504 which is advantageously used for static or fixed data or instructions, such as BIOS functions, system functions, system configuration data, and other routines or data used for operation of the controller 500.

Also included in the controller 500 is random access memory 506, suitably formed of dynamic random access memory, static random access memory, or any other suitable, addressable and writable memory system. Random access memory provides a storage area for data instructions associated with applications and data handling accomplished by processor 502.

A storage interface 508 suitably provides a mechanism for non-volatile, bulk or long term storage of data associated with the controller 500. The storage interface 508 suitably uses bulk storage, such as any suitable addressable or serial storage, such as a disk, optical, tape drive and the like as shown as 516, as well as any suitable storage medium as will be appreciated by one of ordinary skill in the art.

A network interface subsystem 510 suitably routes input and output from an associated network allowing the controller 500 to communicate to other devices. The network interface subsystem 510 suitably interfaces with one or more connections with external devices to the device 500. By way of example, illustrated is at least one network interface card 514 for data communication with fixed or wired networks, such as Ethernet, token ring, and the like, and a wireless interface 518, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 514 is interconnected for data interchange via a physical network 520, suitably comprised of a local area network, wide area network, or a combination thereof.

Data communication between the processor 502, read only memory 504, random access memory 506, storage interface 508 and the network interface subsystem 510 is suitably accomplished via a bus data transfer mechanism, such as illustrated by bus 512.

Also in data communication with bus the 512 is a document processor interface 522. The document processor interface 522 suitably provides connection with hardware 532 to perform one or more document processing operations. Such operations include copying accomplished via copy hardware 524, scanning accomplished via scan hardware 526, printing accomplished via print hardware 528, and facsimile communication accomplished via facsimile hardware 530. It is to be appreciated that the controller 500 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 500 of FIG. 5, (shown in FIG. 1 as the controller 108) as an intelligent subsystem associated with a document processing device. In the illustration of FIG. 6, controller function 600 in the preferred embodiment, includes a document processing engine 602. A suitable controller functionality is that incorporated into the Toshiba e-Studio system in the preferred embodiment. FIG. 6 illustrates suitable functionality of the hardware of FIG. 5 in connection with software and operating system functionality as will be appreciated by one of ordinary skill in the art.

In the preferred embodiment, the engine 602 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 602 is suitably interfaced to a user interface panel 610, which panel allows for a user or administrator to access functionality controlled by the engine 602. Access is suitably enabled via an interface local to the controller, or remotely via a remote thin or thick client.

The engine 602 is in data communication with the print function 604, facsimile function 606, and scan function 608. These functions facilitate the actual operation of printing, facsimile transmission and reception, and document scanning for use in securing document images for copying or generating electronic versions.

A job queue 612 is suitably in data communication with the print function 604, facsimile function 606, and scan function 608. It will be appreciated that various image forms, such as bit map, page description language or vector format, and the like, are suitably relayed from the scan function 608 for subsequent handling via the job queue 612.

The job queue 612 is also in data communication with network services 614. In a preferred embodiment, job control, status data, or electronic document data is exchanged between the job queue 612 and the network services 614. Thus, suitable interface is provided for network based access to the controller function 600 via client side network services 620, which is any suitable thin or thick client. In the preferred embodiment, the web services access is suitably accomplished via a hypertext transfer protocol, file transfer protocol, uniform data diagram protocol, or any other suitable exchange mechanism. The network services 614 also advantageously supplies data interchange with client side services 620 for communication via FTP, electronic mail, TELNET, or the like. Thus, the controller function 600 facilitates output or receipt of electronic document and user information via various network access mechanisms.

The job queue 612 is also advantageously placed in data communication with an image processor 616. The image processor 316 is suitably a raster image process, page description language interpreter or any suitable mechanism for interchange of an electronic document to a format better suited for interchange with device functions such as print 604, facsimile 606 or scan 608.

Finally, the job queue 612 is in data communication with a parser 618, which parser suitably functions to receive print job language files from an external device, such as client device services 622. The client device services 622 suitably include printing, facsimile transmission, or other suitable input of an electronic document for which handling by the controller function 600 is advantageous. The Parser 618 functions to interpret a received electronic document file and relay it to the job queue 612 for handling in connection with the afore-described functionality and components.

In operation, an associated user is first prompted, via a thin client interface, for tab formatting data corresponding to at least one associated electronic document for which a printout is desired. In accordance with one embodiment of the subject application, the tab formatting data includes tab stock identification data representing selected tab sheet stock, position data representing the positioning of the tab sheet stock relative to portions of the electronic document, and caption data representing indicia for printing on the sheet stock. The received tab formatting data is then stored in an associated object file. A document file is then received representing an electronic document associated with the tab formatting data. The electronic document data and the object file are then merged so as to generate output data. The generated output data includes the electronic document data with relative defined tabbed page portions according to the tab formatting data disposed within the object file. Thereafter, a printout of a tangible document according to the electronic data file is commenced, with the tangible document including tab pages printed and interspersed within the tangible document based upon the tab formatting data.

In accordance with one example embodiment of the subject application, pre-defined tab stock property data associated with a plurality of tab stock types is first stored in an associated data storage device. Thus, the skilled artisan will appreciate that the tab stock property data is capable of being stored via the data storage device 112 associated with the document processing device 104, stored in a data storage device (not shown) associated with the user device 116, or the like. Preferably, the pre-defined tab stock property data corresponds to properties associated with tab stock 204 available via at least one of the output media storage trays 110 (200 of FIG. 2A) associated with the document processing device 104. In accordance with one embodiment of the subject application, the tab stock property data corresponds to the type of tab stock, the size, output capabilities, colors, tab orientation, and the like, associated with a given tab stock.

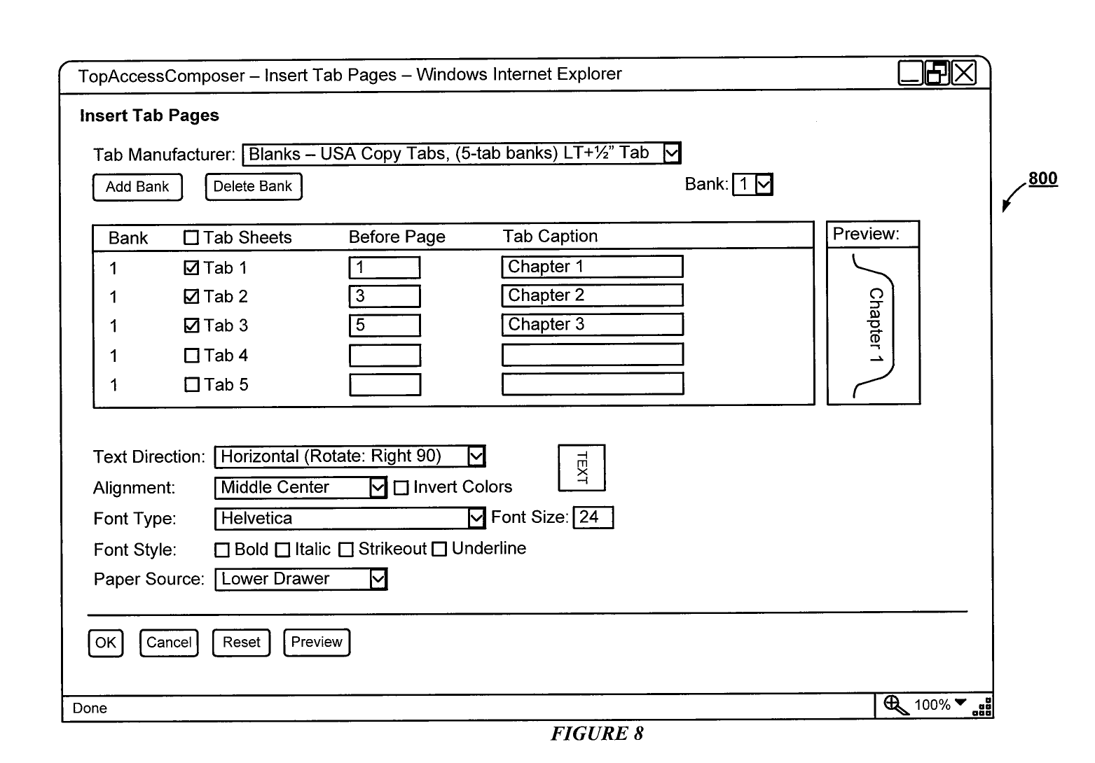

Upon receipt of an electronic document from the user device 116 or via direct interaction by the user with the user interface 106 of the document processing device 104, a graphical user interface, such as that illustrated in FIG. 8, is generated via a thin client interface associated with the user interface 106, the user device 116, or other suitable device of the computer network 102 capable of data communication with the document processing device 104. Further description of the screen template shown in FIG. 8 is included below. Via user interaction with the graphical user interface 106, a determination is made by the controller 108 or other suitable component associated with the document processing device 104 whether tab dividers, e.g., tab sheet stock 204, is desired for inclusion in the tangible output of a received electronic document. When the user does not desire to include tabbed output, the document processing device 104 processes the received electronic document in accordance with the document processing operations selected by the user.

In the event that the user desires to include one or more tabbed sheets within the output of an associated electronic document, the user is prompted via the graphical user interface to select a desired tab stock 204. That is, the user is prompted for tab stock identification data corresponding to one of the available tab sheet stock in the output media trays 110 associated with the document processing device 104. As previously stated, it will be apparent to those skilled in the art that the interaction described herein is capable of being performed via user interaction at the user interface 106, via user interaction at the user device 116, or any other suitable network device capable of displaying the thin client interface associated therewith. Following user selection of a desired tab stock 204, the controller 108 or other suitable component associated with the document processing device 104 retrieves the pre-defined tab sheet stock property data from the associated data storage device 112. In accordance with one embodiment of the subject application, the property data is preferably stored in an extensible markup language (XML) format, as will be appreciated by those skilled in the art.

Following identification and retrieval of tab stock data, the user is then prompted via the graphical user interface, for the position of the selected tab stock 204 within the electronic document. That is, the user is prompted to place the tab sheet 204 amongst the pages of the electronic document in the position desired by the user, e.g., end of a chapter, beginning of a new section, an appendix, drawings, or the like. The user is then prompted to input caption data associated with a caption corresponding to the tab stock sheet 204 placed within the electronic document. That is, the controller 108 or other suitable component associated with the document processing device 104, then receives, from the associated user, text string data inclusive of text selected by the user as caption data. For example, the user is capable of selecting a text string comprising “Chapter” or “Appendix” or the like, as will be needed in accordance with the electronic document to be output by the associated document processing device 104. The user is then able to select the insertion of a number as a portion of the caption data via the associated graphical user interface. When the user desires to insert numeric identifiers into the caption data, a numeric sequence is generated, e.g., “1”, “2”, “3”, etc., in association with the text data. Thus, when the selected text string corresponds to “Chapter”, the result with the numeric sequence as caption data for the tab 206 is “Chapter 1”, or “Chapter 2”, etc., depending upon which number the tab being inserted falls within the sequence.

The user is thereafter prompted to position the caption data on the selected tab sheet via the associated user interface, e.g., centered, left-oriented, right-oriented, top, bottom, or the like. A determination is then made by the controller 108 or other suitable component associated with the document processing device 104 whether another tab sheet 204 is to be inserted into the electronic document. When an additional tab sheet 204 is required, operations return to prompting the user to select the position of the new tab sheet 204, relative to the other pages of the electronic document. Further modifications are then made to the new tab sheet 204 as set forth above. In accordance with one embodiment of the subject application, the controller 108 or other suitable component of the document processing device 104 automatically inserts the caption data into the new tab sheet 204, with the correct numeric sequence, in accordance with where in the electronic document the tab sheet 204 is inserted. For example, when the new tab sheet is inserted after the tab sheet 204 having the caption data “Chapter 1”, the new tab sheet 204 is automatically provided with caption data “Chapter 2”. The user is thereafter capable of modifying the caption data via the methodology set forth above.

Upon a determination that no additional tab sheets are needed, the received tab formatting data, that is, the position of the tab sheet 204, the caption data, the position of the caption data, and the like, are stored in the data storage device 112. Preferably, this tab formatting data is stored in an XML object file on the data storage device 112, in system memory of the document processing device 104, in temporary storage on the user device 116, or the like. Thereafter, the object file is merged with the electronic document file and output data is generated corresponding to the electronic document inclusive of the tab sheets 204. A printout is then commenced by the document processing device 104 resulting in a tangible output of a document having tab sheets inserted in accordance with the user selections.

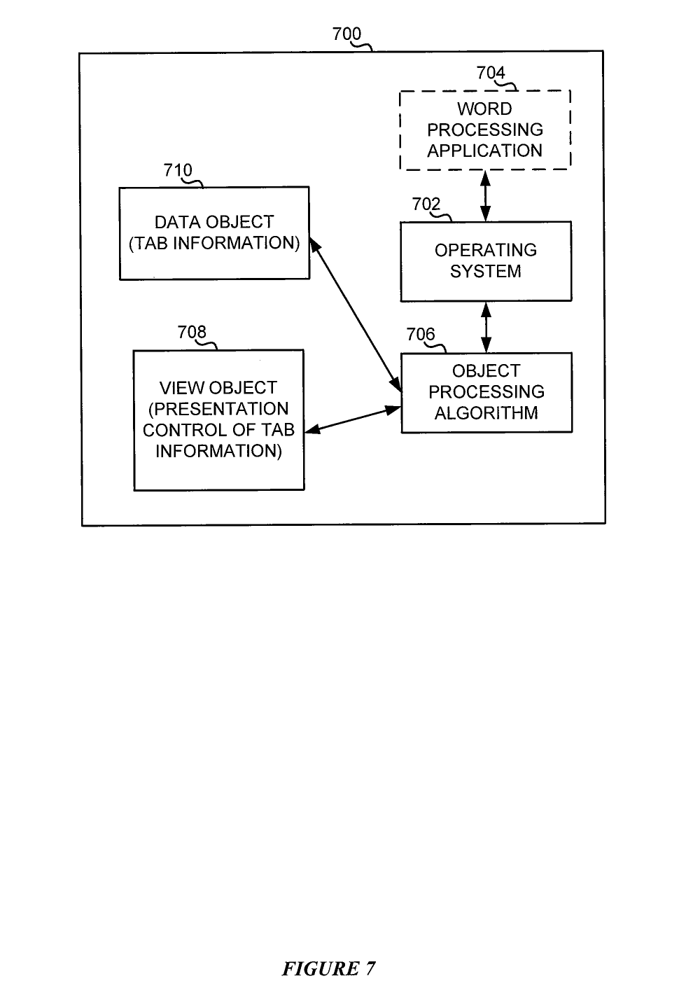

Turning now to FIG. 7, there is illustrated a block diagram of the software object relationship in an operating system context, in accordance with one example embodiment of the subject application. In this particular embodiment, a printer controller system 700, for example the controller 108 of FIG. 1, includes an operating system 702 for operation of the system 700 across a network, or local to a user client. Where the object-based architecture is resident on the user device 116, e.g., a client computer (thick or thin), the system 700 is capable of including one or more applications, e.g., a word processing application 704 with which to utilize the features of the disclosed architecture. In either case, the user invokes the tab text printing features, e.g., within a browser, whether operating from the user device 116 (client system) or the user interface 106 associated with the document processing device 104. The system 700, e.g., the controller 108 or user device 116, also includes a software algorithm 706 that defines the behavior of the tab processing within the system 700 by performing object processing with a view model (or object) 708 and a data model (or object) 710. The code of the software algorithm 706 defines the system behavior during processing and editing of the tab objects.

The view model 708 incorporates various forms and display controls for displaying the tab information in a single-line editable-text format, or tab sheet thumbnail format, or readable-text format, all of which are illustrated hereinbelow.

The data object 710 includes the tab text, related tab attributes, and properties of the tab paper (used in, for example, a printer controller from which the tab sheet 204 will be printed), all of which are encoded in an XML language format. The tab attributes include the text font name and size, the orientation and layout of the text in the tab area, the tab position on the tab sheet 204, and the position of the tab sheet 204 in the overall document compilation. In accordance with one embodiment of the subject application, the object architecture is implemented as a set of XML files that identify both the structure and the order of the tab text, as well as the properties of the tab paper on which the tab text is printed.

The user invokes the tab features to enter or review tab text. When the features are invoked, the user is presented with a dialog that prompts the user for options. When the document is to be printed, the user need only ensure that tab paper 204 is in the peripheral output device (i.e., the printer controller).

Referring now to FIG. 8, there is illustrated a user interface screenshot 800 of the line view provided by the view object, according to a disclosed embodiment. To create a tab, the user selects a menu option denoted Tab Set/New to define a collection of tab sheets as a tab object. The properties of each tab sheet of the collection can be changed by invoking a Tab Paper Properties selection. The Tab Paper Properties menu selection allows the user to modify the number of tabs per sheet, the tab dimensions, and the print properties of the tab text, i.e., font name, font size, and text orientation.

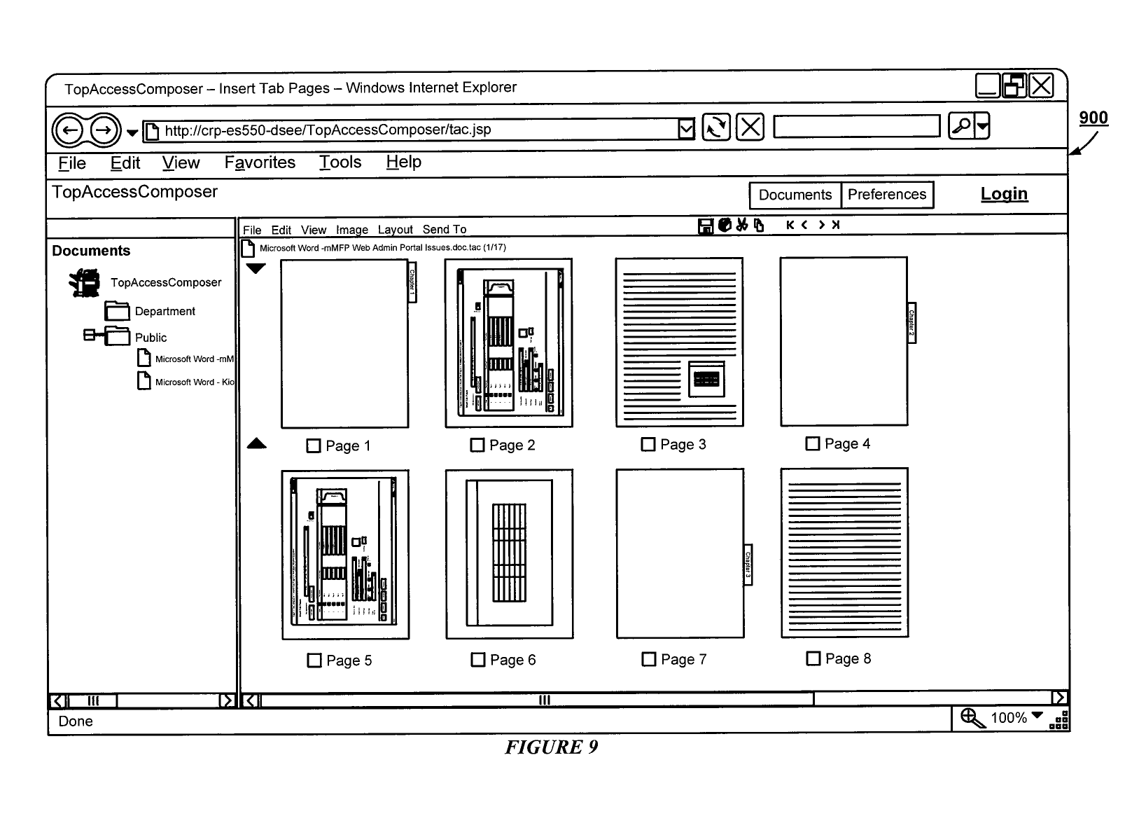

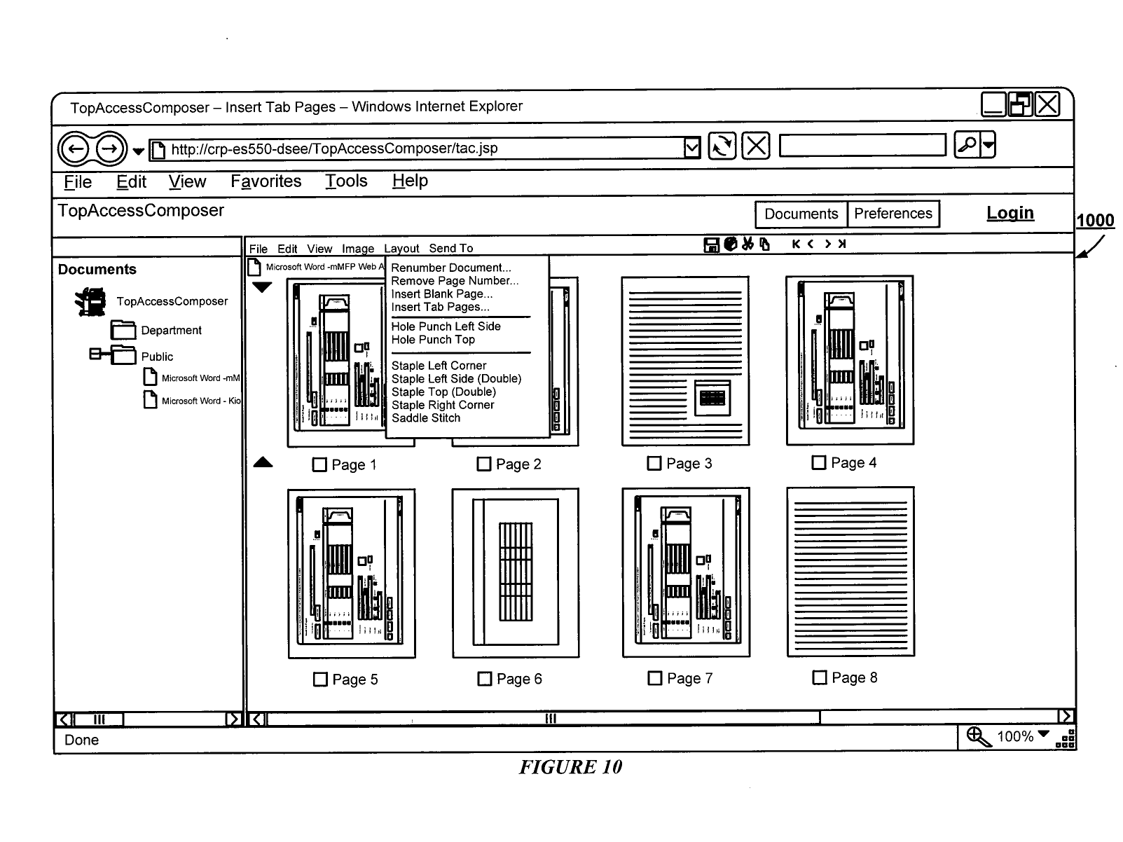

If the user selects a List View option, the text of all the corresponding tabs is displayed in an editable line-by-line list. If the user chooses a Thumbnail View selection, the tab text is displayed as small text in a protruding portion of the tab sheet thumbnail form. FIG. 9 illustrates a screenshot 900 of a thumbnail view of multiple pages, according to a disclosed embodiment. FIG. 10 depicts another screenshot 1000 of the thumbnail view of multiple pages, with the ability for modifications via a pull-down menu according to another embodiment of the subject application.

Continuing with the description of FIG. 8, the user then enters the tab caption in the order of the tab position. A blank entry indicates that no tab text is defined for that particular tab position. The tab positions are associated with the number of tabs 206 per tab sheet 204, and then automatically wrap around to the first position of the next tab set. For example, if the paper is a first set of 5-tab paper, text captions 1-5 are positioned for the five tabs 206 in the first set, and text caption 6 is positioned for the first tab in the next (or second) set of tab paper 204.

To save the tab information and layout, the user chooses a Tab Set/Save or File/Save selection. The tabs data and associated tab properties are then saved to a data file in the XML format.

To copy a tab caption, the user selects the one or more tabs to be copied by placing a check mark in a location associated with the tab 206. The user then chooses an Edit/Copy selection to copy the tabs 206. The data of the check-marked tabs and associated properties are saved to a temporary clipboard file in the XML format.

To insert a new tab 206, the user positions the cursor at the place where the new tab 206 is to be inserted, and chooses an Insert New Tab selection to insert a blank new tab. A blank tab 206 is then inserted, and the view is updated. The user then enters caption text for the new tab 206.

To delete a tab caption, the user selects one or more tabs 206 to be deleted (or cut) by placing a check mark in a field associated with each tab 206. The user then chooses an Edit/Delete selection to delete the tabs 206. The tab data and associated properties information are then deleted from the data object 110 and the view object 108 is updated accordingly.

To move a tab caption, the user selects the one or more tabs 206 to be moved by placing a check mark in a field associated with each tab 206, and chooses an Edit/Cut selection to remove the tabs 206. The data and associated properties information of the cut tabs are then saved to a temporary clipboard file in an XML format. The user then positions the cursor at the destination where the information is to be moved, and chooses an Edit/Paste selection to copy the tab information from the clipboard to the destination.

The following example XML code specifies a tab information source file, the source file location, tab text properties, and tab text orientation for placement on the tab paper 204:

<tabfile>/pbtemp/tab/tab1.png</tabfile>
<tabsource>LC</tabsource>
<tableft>4992</tableft>
<tabtop>100</tabtop>
<tabheight>100</tabheight>
<tabwidth>20</tabwidth>
<tabfontname>Arial</tabfontname>
<tabfontsize>12</tabfontsize>
<taborientation>horizontal</ taborientation >

The following sample XML code specifies the tab orientation and text for various chapter tab sheets 204 in a compilation:

<tabinfo>

<orientation>PORTRAIT</orientation>
<tabtext>Introduction</tabtext>
<tabtext>Chapter 1</tabtext>
<tabtext>Chapter 2</tabtext>

.
.

<tabtext>Chapter 10</tabtext>

</tab>

</tabinfo>

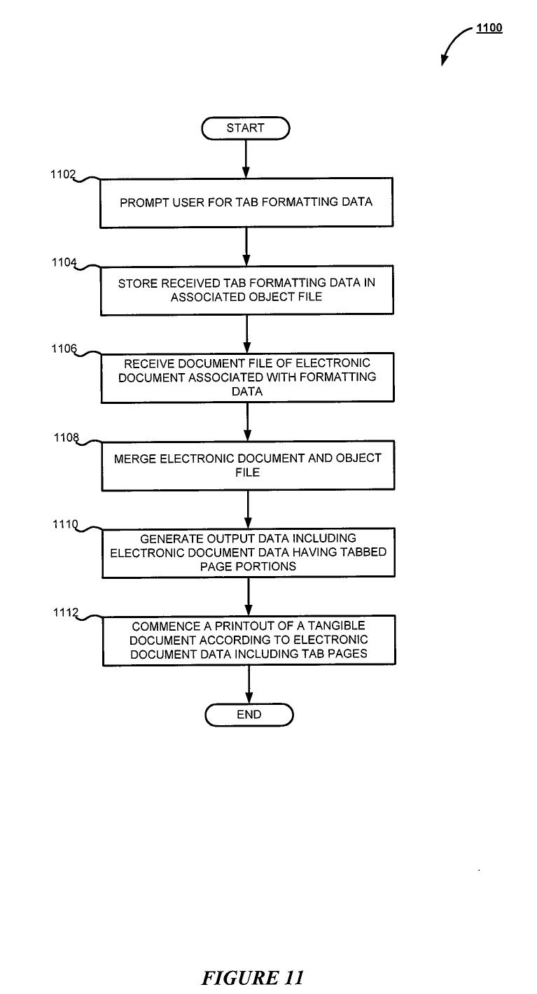

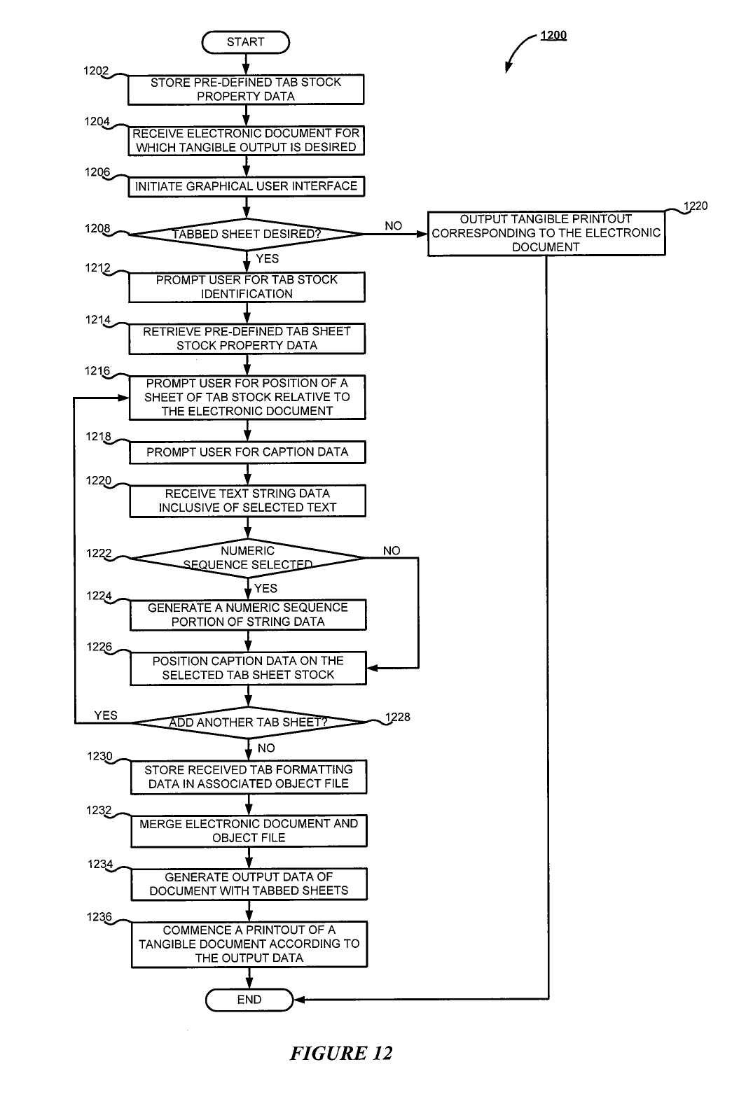

The skilled artisan will appreciate that the subject system 100 and components described above with respect to FIG. 1, FIG. 2A, FIG. 2B, FIG. 3, FIG. 4, FIG. 5, FIG. 6, FIG. 7, FIG. 8, FIG. 9, and FIG. 10 will be better understood in conjunction with the methodologies described hereinafter with respect to FIG. 11 and FIG. 12. Turning now to FIG. 10, there is shown a flowchart 1100 illustrating a method for tab text management in accordance with one embodiment of the subject application. Beginning at step 1102, an associated user is prompted, via a thin client interface associated with the user device 116, the user interface 106, or the like, for tab formatting data corresponding to an associated electronic document that is to be output in tangible form by the document processing device. Preferably, the tab formatting data includes tab stock identification data representing selected tab sheet stock 204, position data representing the positioning of the tab sheet stock 204 relative to portions of the electronic document, and caption data representing indicia for printing on the sheet stock 204.

At step 1104, the received tab formatting data is then stored in an associated object file. A document file corresponding to an electronic document associated with the received tab formatting data is then received at step 1106. The electronic document data and the object file are then merged at step 1108. At step 1110, output data is generated including the electronic document data with relative defined tabbed page portions according to the tab formatting data disposed within the object file. Thereafter, a printout of a tangible document according to the electronic data file is commenced at step 1112, with the tangible document including tab pages 204 printed and interspersed within the tangible document based upon the tab formatting data.

Referring now to FIG. 12, there is shown a flowchart 1200 illustrating a method for tab text management in accordance with one embodiment of the subject application. The methodology depicted in FIG. 12 begins at step 1202, whereupon the controller 108 or other suitable component associated with the document processing device 102 facilitates the storage of pre-defined tab stock property data in the associated data storage device 112. In accordance with on embodiment of the subject application, the tab stock property data corresponds to one or more tab stocks 204 stored in one or more output media trays 110 (storage tray 200 of FIG. 2A) associated with the document processing device 104, e.g., type, size, orientation, color, and the like.

An electronic document is then received at step 1204 from a user associated with the user device 116, the user interface 106, or other device. Following receipt of the electronic document, a graphical user interface is initiated at step 1206 via a thin client interface associated with the user interface 106, the user device 116, or other suitable device of the computer network 102 capable of data communication with the document processing device 104. A determination is then made at step 1208 by the controller 108 or other suitable component associated with the document processing device 104 whether tab dividers, e.g., tab sheet stock 204, is desired for inclusion in the tangible output of the received electronic document. When no tab sheets 204 are required, flow proceeds to step 1210, whereupon the document processing device 104 performs a requested document processing operation on the received electronic document and operations with respect to FIG. 12 terminate.

When it is determined at step 1210 that one or more tab sheets 204 are to be included in the tangible output of the received electronic document, flow proceeds to step 1212. At step 1212, the user is prompted via the graphical user interface for tab stock identification data, i.e., to select one of the available tab sheet stocks 204 in one or more output media trays 110. Following user selection of a desired tab sheet stock 204, the controller 108 or other suitable component associated with the document processing device 104 retrieves pre-defined tab sheet stock property data from the associated data storage device 112 corresponding to the user selected sheet stock 204 at step 1214. In accordance with one embodiment of the subject application, the property data is preferably stored in an extensible markup language (XML) format, as will be appreciated by those skilled in the art.

The user is then prompted at step 1216 via the graphical user interface, for the position of the selected tab stock 204 relative to the other pages within the electronic document. For example, the user selects a position at the end of a chapter, the beginning of a new section, an appendix, drawings, or the like. The user is then prompted at step 1218 for caption data corresponding to a caption corresponding to the tab stock sheet 204 placed within the electronic document. At step 1220, text string data inclusive of user selected text, e.g., “Chapter”, “Appendix”, “Figure”, or the like, is received from the user via the graphical user interface. A determination is then made at step 1222 whether a numeric sequence has been selected by the user. That is, whether the user desires to include numeric identifiers into the caption data, e.g., “1”, “2”, “3”, etc., in association with the text string data. When a numeric sequence is designated by the user, flow proceeds to step 1224 whereupon the s controller 108 or other suitable component associated with the document processing device 104 generates a numeric sequence portion of the caption data. Flow then proceeds to step 1226, with the positioning of the caption data on the selected tab sheet stock 204. Accordingly, when no numeric sequence is requested by the user, operations flow from step 1222 to step 1226. Suitable examples of the positioning of the caption data on the tab sheet stock 204 include, without limitation, centered, left-oriented, right-oriented, top, bottom, or the like. A determination is then made by the controller 108 or other suitable component associated with the document processing device 104 at step 1228 whether another tab sheet 204 is to be inserted into the electronic document.

When an additional tab sheet 204 is required, flow returns to step 1216, whereupon the user is prompted to select the position of the new tab sheet stock 204 with respect to the other pages of the electronic document. Operations continue thereafter to step 1218 as set forth above. It will be appreciated by those skilled in the art that in accordance with one embodiment of the subject application, the controller 108 or other suitable component of the document processing device 104 is capable of being configured to automatically insert caption data into the new tab sheet 204, with the correct numeric sequence, in accordance with the position in the electronic document at which the tab sheet 204 is inserted. For example, when the new tab sheet 204 is inserted after the tab sheet 204 having the caption data “Chapter 1”, the new tab sheet 204 is automatically provided with caption data “Chapter 2”. The user is thereafter capable of modifying the caption data via the methodology set forth above.

Upon a determination that no additional tab sheets 204 are needed at step 1228, flow progresses to step 1230, whereupon the received tab formatting data, e.g., the position of the tab sheet 204, the caption data, the position of the caption data, and the like, are stored in the data storage device 112. Preferably, this tab formatting data is stored in an XML object file on the data storage device 112, in system memory of the document processing device 104, in temporary storage on the user device 116, or the like. Thereafter, the object file is merged with the electronic document file at step 1232. At step 1234, output data is generated corresponding to the electronic document inclusive of the tab sheets 204. A printout is then commenced by the document processing device 104 at step 1236 resulting in a tangible output of a document having tab sheets 204 inserted in accordance with the user selections.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A tab text management system comprising:
interface means adapted for prompting an associated user, via a thin client interface, for tab formatting data corresponding to at least one associated electronic document for which a printout is desired, the tab formatting data including,
tab stock identification data representative of a selected tab sheet stock associated with tab pages,
position data representative of a positioning of tab sheet stock relative to portions of the electronic document, and
caption data representative of indicia for printing on the selected tab sheet stock;
means adapted for storing received tab formatting data in an associated object file;
means adapted for receiving a document data file representative of an electronic document associated with the tab formatting data;
means adapted for merging the electronic document data and the object file so as to generate output data including the electronic document data having tabbed page portions defined relative thereto in accordance with the tab formatting data disposed in the object file; and
means adapted for commencing a printout of a tangible document in accordance with the electronic data file, and which tangible document includes tab pages printed and interspersed therein in accordance with the tab formatting data.

2. The tab text management system of claim 1 further comprising:
means adapted for storing pre-defined tab stock property data associated with a plurality of tab stock types; and
means adapted for positioning caption data on the selected tab sheet stock in accordance with stock property data corresponding to received stock identification data.

3. The tab text management system of claim 1 wherein the interface means further includes means adapted for prompting the associated user for tab formatting data including text string data inclusive of selected text, which string data forms at least a portion of the caption data.

4. The tab text management system of claim 3 further comprising sequencing means adapted for generating a numeric sequence portion of the string data such that tab pages include numerically sequenced data therebetween.

5. The tab text management system of claim 4 further comprising:
means adapted for storing pre-defined tab stock property data associated with a plurality of tab stock types; and
means adapted for positioning caption data on the selected tab sheet stock in accordance with stock property data corresponding to received stock identification data.

6. A tab text management method comprising the steps of:
prompting an associated user, via a thin client interface, for tab formatting data corresponding to at least one associated electronic document for which a printout is desired, the tab formatting data including,
tab stock identification data representative of a selected tab sheet stock associated with tab pages,
position data representative of a positioning of tab sheet stock relative to portions of the electronic document, and
caption data representative of indicia for printing on the selected tab sheet stock;
storing received tab formatting data in an associated object file;
receiving a document data file representative of an electronic document associated with the tab formatting data;
merging the electronic document data and the object file so as to generate output data including the electronic document data having tabbed page portions defined relative thereto in accordance with the tab formatting data disposed in the object file; and
commencing a printout of a tangible document in accordance with the electronic data file, and which tangible document includes tab pages printed and interspersed therein in accordance with the tab formatting data.

7. The tab text management method of claim 6 further comprising the steps of:
storing pre-defined tab stock property data associated with a plurality of tab stock types; and
positioning caption data on the selected tab sheet stock in accordance with stock property data corresponding to received stock identification data.

8. The tab text management method of claim 6 further comprising the step of prompting the associated user for tab formatting data including text string data inclusive of selected text, which string data forms at least a portion of the caption data.

9. The tab text management method of claim 8 further comprising the step of generating a numeric sequence portion of the string data such that tab pages include numerically sequenced data therebetween.

10. The tab text management method of claim 9 further comprising the steps of:
storing pre-defined tab stock property data associated with a plurality of tab stock types; and
positioning caption data on the selected tab sheet stock in accordance with stock property data corresponding to received stock identification data.

11. A computer-implemented method for tab text management comprising the steps of:
prompting an associated user, via a thin client interface, for tab formatting data corresponding to at least one associated electronic document for which a printout is desired, the tab formatting data including,
tab stock identification data representative of a selected tab sheet stock associated with tab pages,
position data representative of a positioning of tab sheet stock relative to portions of the electronic document, and
caption data representative of indicia for printing on the selected tab sheet stock;
storing received tab formatting data in an associated object file;
receiving a document data file representative of an electronic document associated with the tab formatting data;
merging the electronic document data and the object file so as to generate output data including the electronic document data having tabbed page portions defined relative thereto in accordance with the tab formatting data disposed in the object file; and
commencing a printout of a tangible document in accordance with the electronic data file, and which tangible document includes tab pages printed and interspersed therein in accordance with the tab formatting data.

12. The computer-implemented method for tab text management of claim 11 further comprising the steps of:
storing pre-defined tab stock property data associated with a plurality of tab stock types; and
positioning caption data on the selected tab sheet stock in accordance with stock property data corresponding to received stock identification data.

13. The computer-implemented method for tab text management of claim 11 further comprising the step of prompting the associated user for tab formatting data including text string data inclusive of selected text, which string data forms at least a portion of the caption data.

14. The computer-implemented method for tab text management of claim 13 further comprising the step of generating a numeric sequence portion of the string data such that tab pages include numerically sequenced data therebetween.

15. The computer-implemented method for tab text management of claim 14 further comprising the steps of:
storing pre-defined tab stock property data associated with a plurality of tab stock types; and
positioning caption data on the selected tab sheet stock in accordance with stock property data corresponding to received stock identification data.
